(19) United States
(12) Patent Application Publication
(10) Pub. No.: US 2023/0409357 A1
(43) Pub. Date: Dec. 21, 2023

(54) ASYMMETRIC WORKSPACE APPLICATION NOTIFICATION AND INTERACTION

(71) Applicant: Citrix Systems, Inc., Fort Lauderdale, FL (US)

(72) Inventor: Ye He, Nanjing (CN)

(21) Appl. No.: 17/845,559

(22) Filed: Jun. 21, 2022

Related U.S. Application Data
(63) Continuation of application No. PCT/CN22/95004, filed on May 25, 2022.

(51) Int. Cl. G06F 9/451; G06F 9/54; G06F 9/455

(52) U.S. Cl. CPC G06F 9/452; G06F 9/45558; G06F 9/542

(57) ABSTRACT

Methods and systems for implementing asymmetric workspace application notification and interaction are described herein. A computing device may determine a plurality of virtual desktops accessible from an endpoint device via one or more remote sessions associated with a user. The computing device may communicate with agent processes in the virtual desktops to determine user status in the corresponding virtual desktop. The computing device may receive an application notification generated from an application installed on the first virtual desktop. The computing device may determine that the user is active on a second virtual desktop. The computing device may send the application notification to the second virtual desktop and receive a response to the application notification. Accordingly, the computing device may cause an agent process to interact with the application on the first virtual desktop based on the response.

### CROSS-REFERENCE TO RELATED APPLICATION

This Application is a continuation of, and claims priority to co-pending PCT Application No. PCT/CN22/95004, filed May 25, 2022, and entitled “ASYMMETRIC WORKSPACE APPLICATION NOTIFICATION AND INTERACTION,” which is hereby incorporated by reference in its entirety.

### FIELD

Aspects described herein generally relate to computer and network hardware and software. In particular, the present disclosure relates to methods and systems for dynamically routing notifications among multiple virtual desktop instances.

### BACKGROUND

Enterprises are increasingly adopting remote applications and desktops to permit employees to access resources in an enterprise network. A remote server may execute virtual desktops accessible from an endpoint device such that an enterprise user may launch multiple virtual desktop instances concurrently. The user may switch from one virtual desktop instance (e.g., a corporate virtual desktop for a corporate user) to another virtual desktop instance (e.g., a developer virtual desktop instance for the corporate user who is also a software developer). However, keeping multiple virtual desktops open in full screen mode can lead to missing messages and/or duplication of messages among various virtual desktops.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

An enterprise user may execute various virtual desktops accessible from an endpoint device to facilitate her day-to-day work. For example, the user may work as a corporate user in a corporate virtual desktop instance and also work as a software developer in a developer virtual desktop instance. The user may also execute a personal virtual desktop instance. Different applications may be installed, for example, in the corporate virtual desktop instance, the developer virtual desktop instance and the personal virtual desktop instance to support various tasks conducted by the user. Although multiple virtual desktop instances may be executed concurrently and accessible from the endpoint device, the user may be present in only one instance (e.g., an active virtual desktop) at any given time. A notification (e.g., a request) or a message may be generated by an application running in a first virtual desktop, while the user may be actively working in a second virtual desktop. Routing the notification to various virtual desktops indiscriminately may create unnecessary distractions and waste computing power. The user may need to constantly switch back and forth from various virtual desktops to attend to notifications and interactive software operations. As a result, the user's concentration may be hampered and her productivity may suffer. As remote applications and desktops are more frequently adopted and used, it is increasingly important to improve device performance, intelligence and the corresponding user experience to facilitate cross session application interaction, so as to derive the maximum benefit from remote applications and desktops.

To overcome the limitations described above, and to overcome other limitations that will be apparent upon reading and understanding the present specification, aspects described herein are directed toward enhancing remote applications and desktop experiences accessible from endpoint devices (e.g., mobile devices), for example, by implementing asymmetric workspace application notification and interaction.

In accordance with one or more embodiments, a computing device having at least one processor and memory may detect a plurality of virtual desktops which may be accessible from one or more endpoint devices via one or more remote sessions associated with a user. The one or more remote sessions may be provided by a virtual server separate from the computing device implementing asymmetric workspace application notification and interaction. The computing device may receive, via a first agent process running on a first virtual desktop, an application notification generated from an application installed on the first virtual desktop. The computing device may determine that the user is not active on the first virtual desktop. For example, the user may not be present on the first virtual desktop for a predetermined period of time or the user is not actively working in the first virtual desktop. The computer device may determine that the user is active on a second virtual desktop. The computer device may cause the application notification to be presented on the second virtual desktop. The computing device may receive a response to the application notification from a second agent process running on the second virtual desktop. Based on the response, the computer device may cause the first agent process to interact with the application on the first virtual desktop.

More particularly, and as will be described further herein, the computing device may receive system events or user events in a virtual desktop collected via an agent process. The computing device may determine whether the user is active on the virtual desktop based on the system events or user events from the agent process. The user events may include user interactions with an input device, such as a mouse, a keyboard or a microphone. The system events may include system API calls or session status to determine whether the user is active in the relevant virtual desktop.

In many aspects, certain applications may be installed in the first virtual desktop, but not in the second virtual desktop and other applications may be installed in both the first virtual desktop and the second virtual desktop. The computing device may receive data including application notifications from various agent processes running on different virtual desktops. For example, the computing device may receive the applicant notification from the first agent process in the first virtual desktop where the user is not active. The computing device may send the application notification to the second agent process in the second virtual desktop where the user is active. The computing device may cause the second agent process to present the application notification to the user in the second virtual desktop. In some examples, the first agent process may send the application notification to the second agent process. The second agent process may present the application notification to the user that is active in the second virtual desktop. The second agent process may receive a response to the application notification from the user and send the response to the first agent process.

In many aspects, prior to detecting the plurality of virtual desktops, the computing device may register one or more applications executed in the plurality of virtual desktops associated with the user. In some examples, the agent processes may register the one or more applications with the computing device and send the registration information to the computing device. The computing device may configure notifications associated with the one or more applications to be routed from one virtual desktop to another virtual desktop. The notifications may be associated with the application notification and the response to the application notification. The notifications and responses may be related to, for example, a calendar event, an email, or a notification that may need the user's attention. The notifications and responses may carry complicated data or media to be routed from one virtual desktop to another. The plurality of virtual desktops may be associated with concurrent remote sessions launched by the user.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative enterprise mobility management system in accordance with one or more illustrative aspects described herein.

FIG. 6 depicts another illustrative enterprise mobility management system in accordance with one or more illustrative aspects described herein.

FIGS. 7A and 7B depict an illustrative computing environment for implementing asymmetric workspace application notification and interaction in accordance with one or more example embodiments.

FIG. 8 depicts an illustrative system for implementing asymmetric workspace application notification and interaction in accordance with one or more example embodiments.

FIGS. 9A-9C depict an example event sequence for implementing asymmetric workspace application notification and interaction in accordance with one or more illustrative aspects described herein.

FIG. 10 depicts an example method of implementing asymmetric workspace application notification and interaction in accordance with one or more illustrative aspects described herein.

FIG. 11A depicts an example event sequence for implementing asymmetric workspace application notification and interaction using one or more agent processes in accordance with one or more illustrative aspects described herein.

FIG. 11B depicts an example event sequence using one or more agent processes to determine a user status in a virtual desktop in accordance with one or more illustrative aspects described herein.

### DETAILED DESCRIPTION

In the following description of the various examples, reference is made to the accompanying drawings identified above and which form a part hereof, and in which is shown by way of illustration various examples in which aspects described herein may be practiced. It is to be understood that other examples may be utilized and structural and functional modifications may be made without departing from the scope described herein. Various aspects are capable of other examples and of being practiced or being carried out in various different ways.

As a general introduction to the subject matter described in more detail below, aspects described herein are directed towards enhancing remote applications and desktop experiences on endpoint devices (e.g., mobile devices), for example, by implementing asymmetric workspace application notification and interaction. As discussed previously, an enterprise user may launch multiple virtual desktops concurrently, and different applications may be installed in each virtual desktop. A notification (e.g., an application notification) or a message may be generated by an application running in a first virtual desktop, while the user may be actively working in a second virtual desktop. Routing the notification to various virtual desktops indiscriminately may create unnecessary distractions to the user and waste computing power.

The disclosure herein improves the functioning of computing devices, and in particular the process of routing workspace application notification and interaction, by providing an intelligent routing mechanism of the notifications across various virtual desktop to facilitate operations and improve user experience. The process described herein records or registers multiple user session data to allow cross session application interaction. The process described herein allows endpoint devices to access multiple virtual desktops in a manner which avoids cumbersome notifications. In other words, the process described herein improves the functioning of computing devices when facilitating communications and interactions across various virtual desktops while also making those computing devices easier to use.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

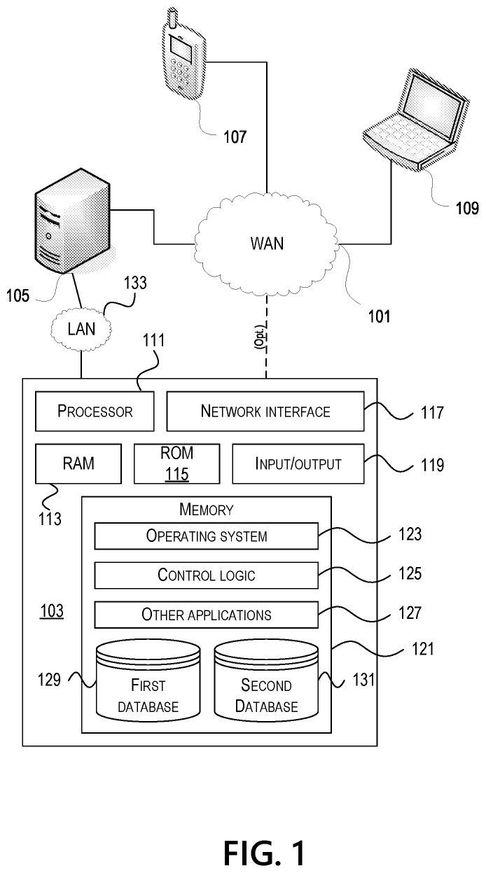

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some examples, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to device 103. The functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

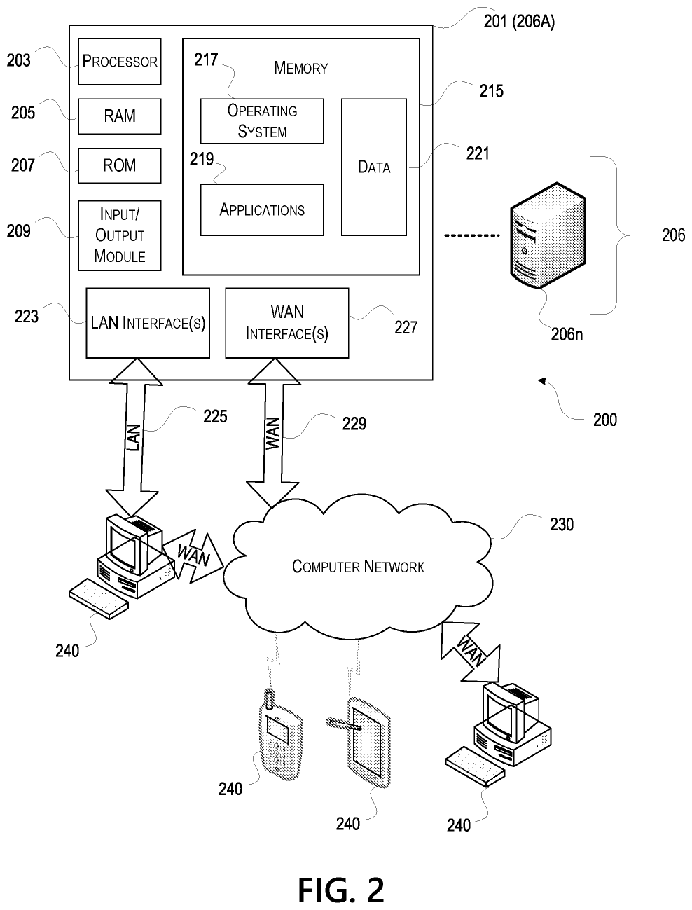

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) configured to provide virtual machines for client access devices. The computing device 201 may have a processor 203 for controlling overall operation of the server and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as computer network 230 (e.g., the Internet). The network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one example, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some examples be referred to as a single client machine 240 or a single group of client machines 240, while server(s) 206 may be referred to as a single server 206 or a single group of servers 206. In one example a single client machine 240 communicates with more than one server 206, while in another example a single server 206 communicates with more than one client machine 240. In yet another example, a single client machine 240 communicates with a single server 206.

A client machine 240 can, in some examples, be referenced by any one of the following non-exhaustive terms: client machine(s); client(s); client computer(s); client device(s); client computing device(s); local machine; remote machine; client node(s); endpoint(s); or endpoint node(s). The server 206, in some examples, may be referenced by any one of the following non-exhaustive terms: server(s), local machine; remote machine; server farm(s), or host computing device(s).

In one example, the client machine 240 may be a virtual machine (and/or a domain). The virtual machine may be any virtual machine, while in some examples the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some examples include a client device 240 that displays application output generated by an application remotely executing on a server 206 or other remotely located machine. In these examples, the client device 240 may execute a virtual machine receiving program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some examples, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while and logically grouped together, or servers 206 that are located proximate to each other while logically grouped together. Geographically dispersed servers 206a-206n within a server farm 206 can, in some examples, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some examples the server farm 206 may be administered as a single entity, while in other examples the server farm 206 can include multiple server farms.

In some examples, a server farm may include servers 206 that execute a substantially similar type of operating system platform (e.g., WINDOWS, UNIX, LINUX, iOS, ANDROID, SYMBIAN, etc.) In other examples, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some examples include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 and well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

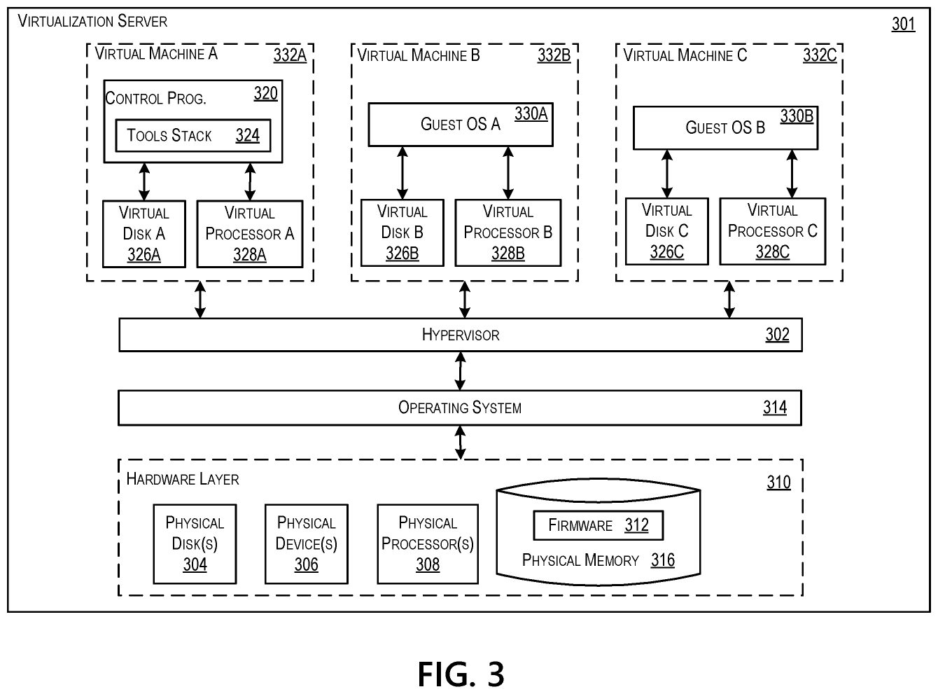

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

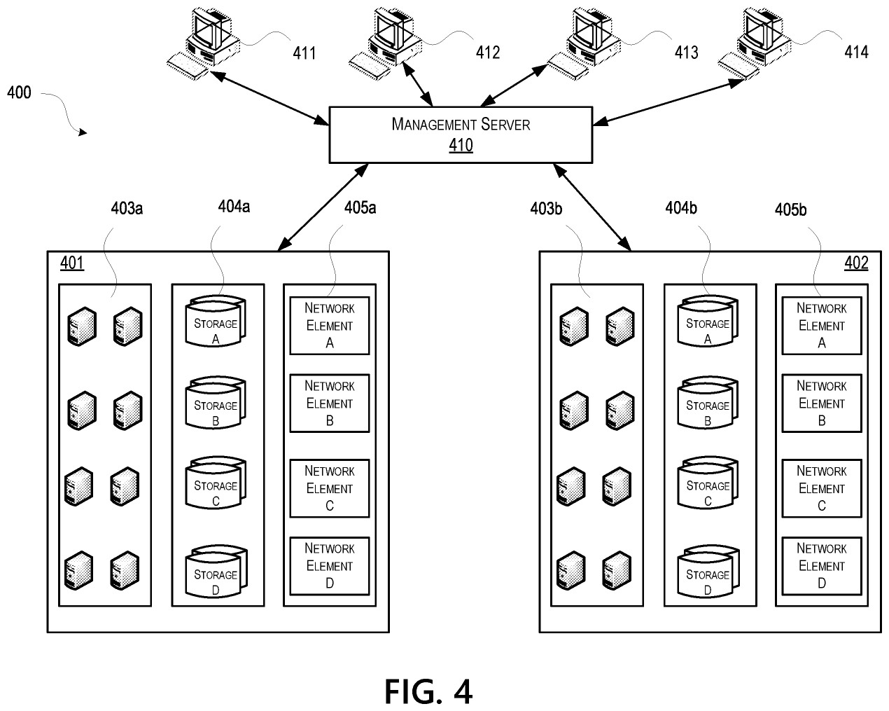

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Enterprise Mobility Management Architecture

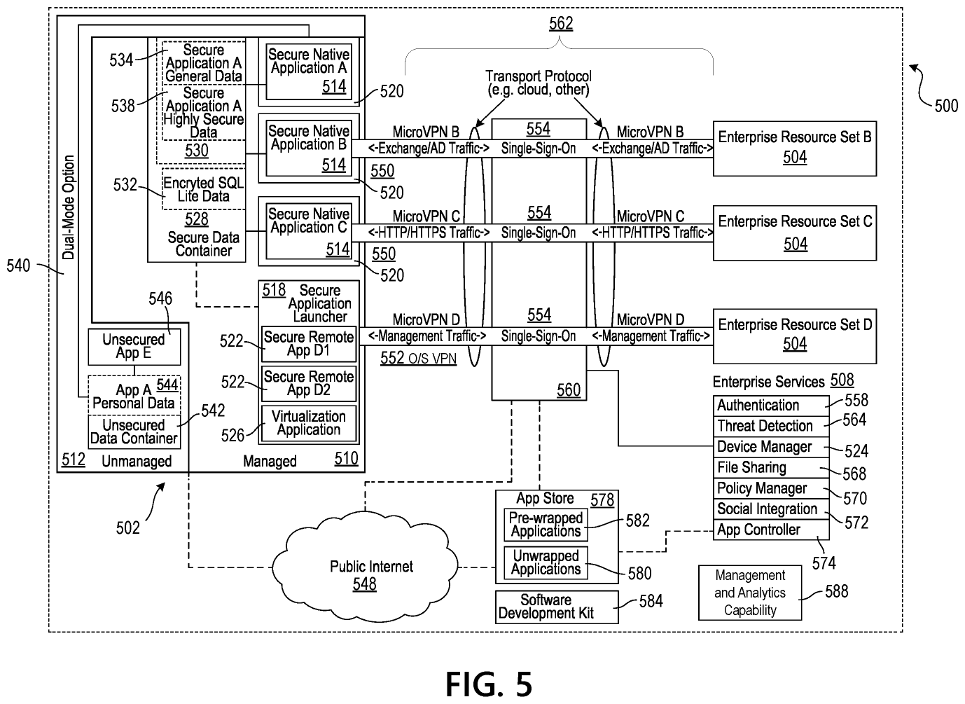

FIG. 5 represents an enterprise mobility technical architecture 500 for use in a “Bring Your Own Device” (BYOD) environment. The architecture enables a user of a mobile device 502 to both access enterprise or personal resources from a mobile device 502 and use the mobile device 502 for personal use. The user may access such enterprise resources 504 or enterprise services 508 using a mobile device 502 that is purchased by the user or a mobile device 502 that is provided by the enterprise to the user. The user may utilize the mobile device 502 for business use only or for business and personal use. The mobile device 502 may run an iOS operating system, an Android operating system, or the like. The enterprise may choose to implement policies to manage the mobile device 502. The policies may be implemented through a firewall or gateway in such a way that the mobile device 502 may be identified, secured or security verified, and provided selective or full access to the enterprise resources (e.g., 504 and 508.) The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of the mobile device 502 may be separated into a managed partition 510 and an unmanaged partition 512. The managed partition 510 may have policies applied to it to secure the applications running on and data stored in the managed partition 510. The applications running on the managed partition 510 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 502. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. The secure native applications 514 may be wrapped by a secure application wrapper 520. The secure application wrapper 520 may include integrated policies that are executed on the mobile device 502 when the secure native application 514 is executed on the mobile device 502. The secure application wrapper 520 may include meta-data that points the secure native application 514 running on the mobile device 502 to the resources hosted at the enterprise (e.g., 504 and 508) that the secure native application 514 may require to complete the task requested upon execution of the secure native application 514. The secure remote applications 522 executed by a secure application launcher 518 may be executed within the secure application launcher 518. The virtualization applications 526 executed by a secure application launcher 518 may utilize resources on the mobile device 502, at the enterprise resources 504, and the like. The resources used on the mobile device 502 by the virtualization applications 526 executed by a secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 504, and the like. The resources used at the enterprise resources 504 by the virtualization applications 526 executed by a secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application 526 may record user interactions associated with a graphical user interface (GUI) and communicate them to a server application where the server application will use the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on the mobile device 502, this arrangement may also be elected for certain applications. For example, while some applications may be secured for use on the mobile device 502, others might not be prepared or appropriate for deployment on the mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device 502 as well as a virtualization application 526 to allow access to applications that are deemed more properly operated on the server side. In an embodiment, the virtualization application 526 may store some data, files, etc. on the mobile device 502 in one of the secure storage locations. An enterprise, for example, may elect to allow certain information to be stored on the mobile device 502 while not permitting other information.

In connection with the virtualization application 526, as described herein, the mobile device 502 may have a virtualization application 526 that is designed to present GUIs and then record user interactions with the GUI. The virtualization application 526 may communicate the user interactions to the server side to be used by the server side application as user interactions with the application. In response, the application on the server side may transmit back to the mobile device 502 a new GUI. For example, the new GUI may be a static page, a dynamic page, an animation, or the like, thereby providing access to remotely located resources.

The secure applications 514 may access data stored in a secure data container 528 in the managed partition 510 of the mobile device 502. The data secured in the secure data container may be accessed by the secure native applications 514, secure remote applications 522 executed by a secure application launcher 518, virtualization applications 526 executed by a secure application launcher 518, and the like. The data stored in the secure data container 528 may include files, databases, and the like. The data stored in the secure data container 528 may include data restricted to a specific secure application 530, shared among secure applications 532, and the like. Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in the secure data container 528 may be deleted from the mobile device 502 upon receipt of a command from the device manager 524. The secure applications (e.g., 514, 522, and 526) may have a dual-mode option 540. The dual mode option 540 may present the user with an option to operate the secured application in an unsecured or unmanaged mode. In an unsecured or unmanaged mode, the secure applications may access data stored in an unsecured data container 542 on the unmanaged partition 512 of the mobile device 502. The data stored in an unsecured data container may be personal data 544. The data stored in an unsecured data container 542 may also be accessed by unsecured applications 546 that are running on the unmanaged partition 512 of the mobile device 502. The data stored in an unsecured data container 542 may remain on the mobile device 502 when the data stored in the secure data container 528 is deleted from the mobile device 502. An enterprise may want to delete from the mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 502 may connect to enterprise resources 504 and enterprise services 508 at an enterprise, to the public Internet 548, and the like. The mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of the mobile device 502 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. The authentication service 558 may then grant to the user access to multiple enterprise resources 504, without requiring the user to provide authentication credentials to each individual enterprise resource 504.

The virtual private network connections may be established and managed by an access gateway 560. The access gateway 560 may include performance enhancement features that manage, accelerate, and improve the delivery of enterprise resources 504 to the mobile device 502. The access gateway 560 may also re-route traffic from the mobile device 502 to the public Internet 548, enabling the mobile device 502 to access publicly available and unsecured applications that run on the public Internet 548. The mobile device 502 may connect to the access gateway via a transport network 562. The transport network 562 may use one or more transport protocols and may be a wired network, wireless network, cloud network, local area network, metropolitan area network, wide area network, public network, private network, and the like.

The enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 504 may be premise-based resources, cloud-based resources, and the like. The enterprise resources 504 may be accessed by the mobile device 502 directly or through the access gateway 560. The enterprise resources 504 may be accessed by the mobile device 502 via the transport network 562.

The enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on the mobile device 502, by the enterprise resources 504, and the like. The certificates stored on the mobile device 502 may be stored in an encrypted location on the mobile device 502, the certificate may be temporarily stored on the mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

The enterprise mobility technical architecture 500 may include an application store 578. The application store 578 may include unwrapped applications 580, pre-wrapped applications 582, and the like. Applications may be populated in the application store 578 from the application controller 574. The application store 578 may be accessed by the mobile device 502 through the access gateway 560, through the public Internet 548, or the like. The application store 578 may be provided with an intuitive and easy to use user interface.

A software development kit 584 may provide a user the capability to secure applications selected by the user by wrapping the application as described previously in this description. An application that has been wrapped using the software development kit 584 may then be made available to the mobile device 502 by populating it in the application store 578 using the application controller 574.

The enterprise mobility technical architecture 500 may include a management and analytics capability 588. The management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

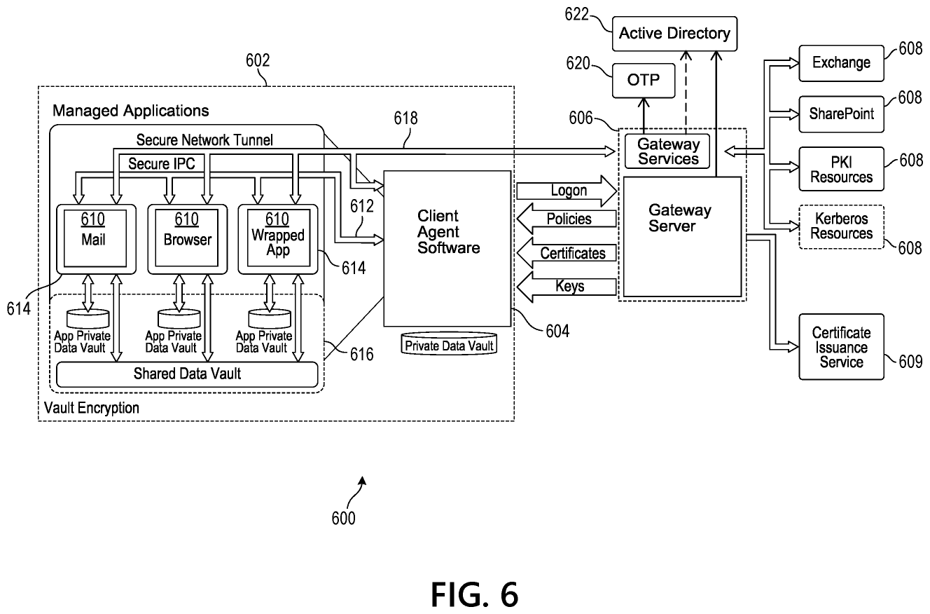

FIG. 6 is another illustrative enterprise mobility management system 600. Some of the components of the mobility management system 500 described above with reference to FIG. 5 have been omitted for the sake of simplicity. The architecture of the system 600 depicted in FIG. 6 is similar in many respects to the architecture of the system 500 described above with reference to FIG. 5 and may include additional features not mentioned above.

In this case, the left hand side represents an enrolled mobile device 602 with a client agent 604, which interacts with gateway server 606 (which includes Access Gateway and application controller functionality) to access various enterprise resources 608 and services 609 such as Exchange, Sharepoint, public-key infrastructure (PM) Resources, Kerberos Resources, Certificate Issuance service, as shown on the right hand side above. Although not specifically shown, the mobile device 602 may also interact with an enterprise application store (StoreFront) for the selection and downloading of applications.

The client agent 604 acts as the UI (user interface) intermediary for Windows apps/desktops hosted in an Enterprise data center, which are accessed using the High-Definition User Experience (HDX)/ICA display remoting protocol. The client agent 604 also supports the installation and management of native applications on the mobile device 602, such as native iOS or Android applications. For example, the managed applications 610 (mail, browser, wrapped application) shown in the figure above are all native applications that execute locally on the mobile device 602. Client agent 604 and application management framework of this architecture act to provide policy driven management capabilities and features such as connectivity and SSO (single sign on) to enterprise resources/services 608. The client agent 604 handles primary user authentication to the enterprise, normally to Access Gateway (AG) 606 with SSO to other gateway server components. The client agent 604 obtains policies from gateway server 606 to control the behavior of the managed applications 610 on the mobile device 602.

The Secure InterProcess Communication (IPC) links 612 between the native applications 610 and client agent 604 represent a management channel, which may allow a client agent to supply policies to be enforced by the application management framework 614 “wrapping” each application. The IPC channel 612 may also allow client agent 604 to supply credential and authentication information that enables connectivity and SSO to enterprise resources 608. Finally, the IPC channel 612 may allow the application management framework 614 to invoke user interface functions implemented by client agent 604, such as online and offline authentication.

Communications between the client agent 604 and gateway server 606 are essentially an extension of the management channel from the application management framework 614 wrapping each native managed application 610. The application management framework 614 may request policy information from client agent 604, which in turn may request it from gateway server 606. The application management framework 614 may request authentication, and client agent 604 may log into the gateway services part of gateway server 606 (for example, Citrix Gateway). Client agent 604 may also call supporting services on gateway server 606, which may produce input material to derive encryption keys for the local data vaults 616, or may provide client certificates which may enable direct authentication to PKI protected resources, as more fully explained below.

In more detail, the application management framework 614 “wraps” each managed application 610. This may be incorporated via an explicit build step, or via a post-build processing step. The application management framework 614 may “pair” with client agent 604 on first launch of an application 610 to initialize the Secure IPC channel 612 and obtain the policy for that application. The application management framework 614 may enforce relevant portions of the policy that apply locally, such as the client agent login dependencies and some of the containment policies that restrict how local OS services may be used, or how they may interact with the managed application 610.

The application management framework 614 may use services provided by client agent 604 over the Secure IPC channel 612 to facilitate authentication and internal network access. Key management for the private and shared data vaults 616 (containers) may be also managed by appropriate interactions between the managed applications 610 and client agent 604. Vaults 616 may be available only after online authentication, or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. The application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

The Mail and Browser managed applications 610 have special status and may make use of facilities that might not be generally available to arbitrary wrapped applications. For example, the Mail application 610 may use a special background network access mechanism that allows it to access an Exchange server 608 over an extended period of time without requiring a full AG logon. The Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 616 (containers) on the mobile device 602. The vaults 616 may be encrypted so that all on-device data including files, databases, and configurations are protected. For on-line vaults, the keys may be stored on the server (gateway server 606), and for off-line vaults, a local copy of the keys may be protected by a user password or biometric validation. If or when data is stored locally on the mobile device 602 in the secure container 616, it may be preferred that a minimum of AES 256 encryption algorithm be utilized.

Other secure container features may also be implemented. For example, a logging feature may be included, wherein security events happening inside a managed application 610 may be logged and reported to the backend. Data wiping may be supported, such as if or when the managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the mobile device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of an AD (active directory) 622 password for access to one or more applications. In some cases, some users do not know (or are not permitted to know) their AD password, so these users may authenticate using an OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner In this case, the client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PM protected web resources via the application management framework micro VPN feature). For example, a managed application 610 may utilize such a certificate. In this case, certificate-based authentication using ActiveSync protocol may be supported, wherein a certificate from the client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PM protected resources.

The client agent 604 and the application management framework 614 may be enhanced to support obtaining and using client certificates for authentication to internal PM protected network resources. More than one certificate may be supported, such as to match various levels of security and/or separation requirements. The certificates may be used by the Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that a mobile device 602 is authenticated to the enterprise, and vice versa. Virtual smart cards for authentication to gateway server 606 may also be implemented.

Another feature may relate to application container locking and wiping, which may automatically occur upon jail-break or rooting detections, and occur as a pushed command from administration console, and may include a remote wipe functionality even when a managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

### Asymmetric Workspace Application Notification and Interaction

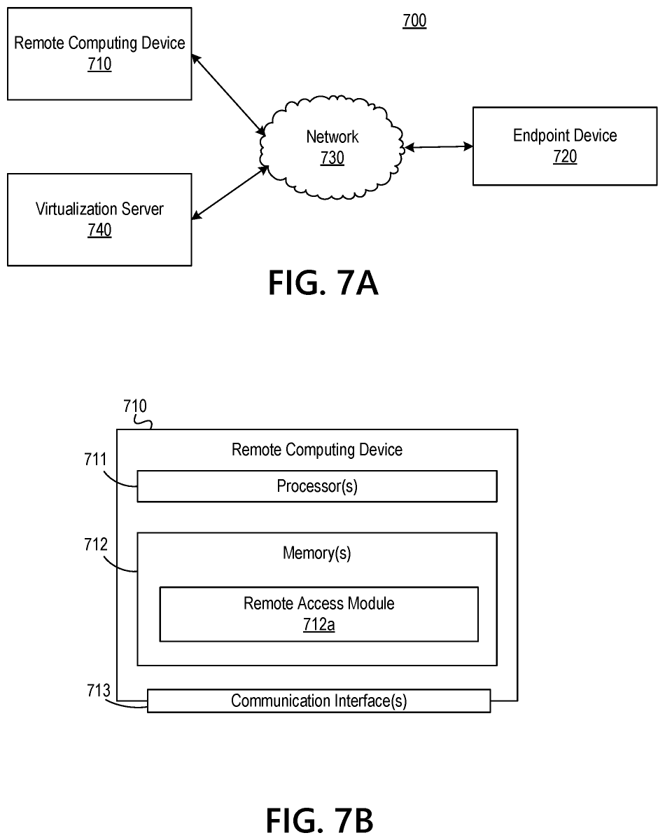

FIGS. 7A and 7B depict an illustrative computing environment for implementing asymmetric workspace application notification and interaction in accordance with one or more example embodiments. The applications may be web browsing applications, software-as-a-service (SaaS) access applications, or the like. For example, a web browsing application may include one or more elements, such as a search bar for the user to input a search term or phrase. The web browsing application may include an element such as a close button to close or exit the web browsing application. Referring to FIG. 7A, computing environment 700 may include one or more computer systems. For example, computing environment 700 may include a remote computing device 710 that implements asymmetric workspace application notification and interaction, an endpoint device (e.g., mobile device) 720, and one or more virtualization servers 740 (which may, e.g., be a computing device similar to virtualization server 301, shown in FIG. 3, or virtualization servers 403, shown in FIG. 4) configured to provide virtual desktops and/or virtual applications to the endpoint device 720.

As illustrated in greater detail below, remote computing device 710 may be a computer system that includes one or more computing devices and/or other computer components (e.g., processors, memories, communication interfaces, servers, server blades, or the like) configured to perform one or more of the functions described herein. Virtualization servers 740 may be configured to host one or more remote applications or desktops (e.g., a remote desktop server). In some examples, the remote computing device 710 and the virtualization servers 740 may reside on a same server.

As illustrated in greater detail below, endpoint device (e.g., mobile device) 720 (which may, e.g., be a computing device similar to device 107, shown in FIG. 1, or client machine 240, shown in FIG. 2) may be a desktop computer, a computer server, a mobile device (e.g., a laptop computer, a tablet computer, a smart phone, any other types of mobile computing devices, and the like), and/or any other type of data processing device. In addition, endpoint device 720 may be configured to establish a remote application or desktop session (e.g., with the remote computing device 710). In some instances, remote computing device 710 may be similar to virtualization server 301, which is shown in FIG. 3.

Computing environment 700 may also include one or more networks, which may interconnect remote computing device 710, endpoint device 720 and virtualization servers 740. For example, computing environment 700 may include a network 730 (which may e.g., interconnect remote computing device 710 and endpoint device 720). In some instances, the network 730 may be similar to computer network 230, which is shown in FIG. 2.

In one or more arrangements, remote computing device 710, endpoint device 720, virtualization servers 740, and/or the other systems included in computing environment 700 may be any type of computing device capable of receiving a user interface, receiving input via the user interface, and communicating the received input to one or more other computing devices. For example, remote computing device 710, endpoint device 720, virtualization servers 740, and/or the other systems included in computing environment 700 may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of remote computing device 710, endpoint device 720, and/or virtualization servers 740 may, in some instances, be special purpose computing devices configured to perform specific functions.

Referring to FIG. 7B, remote computing device 710 may include one or more processors 711, memory 712, and communication interface 713. A data bus may interconnect processor 711, memory 712, and communication interface 713. Communication interface 713 may be a network interface configured to support communication between the remote computing device 710 and one or more networks (e.g., network 730, or the like). Memory 712 may include one or more program modules having instructions that when executed by processor 711 cause remote computing device 710 to perform one or more functions described herein and/or access one or more databases that may store and/or otherwise maintain information which may be used by such program modules and/or processor 711. In some instances, the one or more program modules and/or databases may be stored by and/or maintained in different memory units of remote computing device 710. For example, memory 712 may have, host, store, and/or include a remote access module 712a. Remote access module 712a may cause or otherwise enable the remote computing device 710 to establish a remote application or desktop session (e.g., with endpoint device 720), as described in greater detail below.

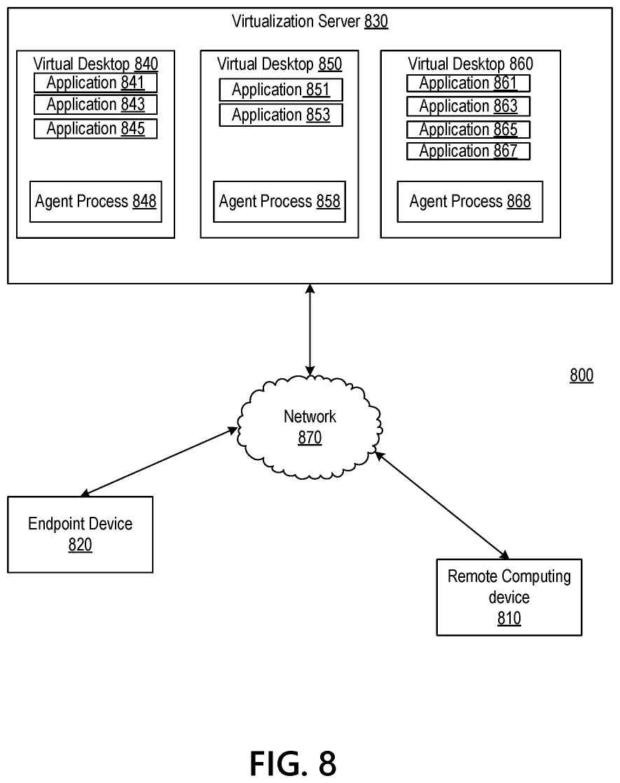

FIG. 8 depicts an illustrative system for implementing asymmetric workspace application notification and interaction in accordance with one or more example embodiments. Referring to FIG. 8, system 800 may include a remote computing device 810, an endpoint device 820, a virtualization server 830 and a network 870. Remote computing device 810, endpoint device 820 and virtualization server 830 may include one or more physical components, such as one or more processors, memories, communication interfaces, and/or the like. In some instances, remote computing device 810 may be similar to remote computing device 710, endpoint device 820 may be similar to endpoint device 720, virtualization server 830 may be similar to virtualization servers 740 and network 870 may be similar to network 730, which are shown in FIG. 7.

Virtualization server 830 may be configured to host a workspace which may be accessed via endpoint device 820. The workspace may be a software platform enabling enterprise users to remotely access and operate virtual desktops 840-860 running in a cloud computing environment. The workspace may include, for example, Citrix Workspace, Microsoft Teams, Skype and Google Workspace. Enterprise users may access the workspace via endpoint device 820, and workspace may be a virtual environment hosting applications, content and devices associated with an organization. For example, Citrix Workspace is a digital workspace software platform that may allow multiple enterprise users to remotely access and operate Microsoft Windows desktops running in a datacenter or a public or private cloud, via endpoint devices. Enterprise users may access virtual desktops and applications through Citrix Workspace wrapped applications that delivered and managed as managed applications of 610 in FIG. 6. Google Workspace may include collaboration tools such as Gmail, Calendar, Meet, Chat, Drive, Docs, Sheets, Slides, Forms and Sites. A workspace may also include instant messaging tools such as Microsoft Teams, Skype, communication platform such as Slack, JIRA ticketing platform or Confluence pages. A workspace may also include other applications or tools suitable to support the day-to-day work of the enterprise users.

As illustrated in FIG. 8, an enterprise user may launch one or more virtual desktops 840-860 in the workspace accessible via endpoint device 820. Each virtual desktops 840-860 may host one or more applications (e.g., workspace applications). In the example of FIG. 8, the workspace applications may be asymmetric. For example, virtual desktop 840 hosts three applications 841, 843 and 845; virtual desktop 850 hosts two applications 851 and 853; and virtual desktop 860 hosts four applications 861, 863, 865 and 867. Each virtual desktops 840-860 may also be symmetric, meaning they host the same number or same types of applications, or they may host the same applications. The user may access applications executing in the workspace. Although FIG. 8 depicts three concurrent virtual desktops 840-860 that are visible to the user in the workspace, it is also possible only the active virtual desktop (e.g., virtual desktop 850) may be displayed in the workspace at any given time. The inactive virtual desktops may be running in the background not visible to the user. Workspace applications may include one or more communication or collaboration tools that the enterprise users may use to communicate with each other. For example, application 841 may be a mail, browser or other wrapped applications 610 as illustrated in FIG. 6. Workspace applications may be Software as a Service (SaaS) applications published by the workspace. Workspace applications may be instant messaging tools such as Microsoft Teams, Skype, communication platforms such as Slack or JIRA service management system, or collaboration tools such as Confluence platform.

An enterprise user may execute multiple virtual desktops 840-860 in the workspace, and the user may actively engage with one virtual desktops at any given time. Each virtual desktops 840-860 may have one or more agent processes installed. For example, Agent Process 848 may be installed in virtual desktop 840, Agent Process 858 may be installed in virtual desktop 850 and Agent Process 868 may be installed in virtual desktop 860. Agent Processes 848, 858 and 868 may work as an intermediate between remote computing device 810 and a virtual desktop instance hosted on virtualization server 830. Agent Processes 848, 858 and 868 may be similar to client agent 604 as illustrated in FIG. 6. Agent Processes 848, 858 and 868 may communicate with remote computing device 810 via network 870. Agent Processes 848, 858 and 868 may also communicate with each other directly or indirectly. Agent Processes 848, 858 and 868 may monitor the status of virtual desktops 840-860 and send the status to remote computing device 810 or other Agent Processes. Agent Processes 848, 858 and 868 may capture application notifications generated from the applications in the virtual desktops and send the application notifications to remote computing device 810. Agent Processes 848, 858 and 868 may receive responses to the application notifications from the remote computing device 810. Alternatively and additionally, Agent Processes 848, 858 and 868 may send and receive application notifications and responses to each other. Agent Processes 848, 858 and 868 may also interact with the applications locally based on the received responses to the application notifications. For example, Agent Processes 848 may capture an application notification from application 841 and send the application notification to Agent Processes 858. Agent Processes 858 may receive the application notification and capture a response from the user. Agent Processes 858 may send the response to Agent Processes 848 and Agent Processes 848 may in turn, interact with application 841 locally based on the response.

Remote computing device 810 may communicate with the agent processes running in various virtual desktop instances. For example, the user may execute three instances of virtual desktops 840-860 in the workspace. Remote computing device 810 may receive the status of each workspace instance from the agent processes and determine which instance is active at any given time. The agent processes may collect system events (e.g., system API calls) or user events (e.g., user interactions with a mouse or keyboard) and send to the computing device 810. Computing device 810 may determine whether the user is active on a particular virtual desktop based on the system events and user events from the agent processes. For example, remote computing device may determine that the user is actively working on virtual desktop 860 and not on virtual desktops 850 and 870 at the moment. In some examples, the agent processes may directly send status of the user (e.g., active or inactive) in the corresponding virtual desktop to the remote computing device.

Remote computing device 810 may receive an application notification, for example, from Agent Process 848 on virtual desktop 840. The application notification may be a meeting invite generated from Microsoft Teams on virtual desktop 840. Remote computing device 810 may send the notification to Agent Process 858 to be displayed on virtual desktop 850, where the user is actively working on. If the user provides a response, such as an acceptance or rejection on the invite, remote computing device 810 may receive the response from Agent Process 858 on virtual desktop 850 and send such response to Agent Process 848 so that Agent Process 848 may interact with the Microsoft Teams application on virtual desktop 840. Rather than acting as an intermediate between the Agent Processes, remote computing device 810 may also cause Agent Processes 848 and 858 to interact directly with each other to receive and send the application notification and response.

Remote computing device 810 may register, via the agent processes, one or more applications in the virtual desktops associated with a user to stipulate whether an application notification generated in one virtual desktop may be routed to another virtual desktop. The registration process may be performed in a configuration step based on the user's preferences. For example, the user may indicate that, when she works on another virtual desktop, she prefers to receive notifications related to Teams invite from her corporate account, but not her person account. The user may indicate that, when she works on another virtual desktop, she prefers to receive notifications related to emails that were sent with high priority, but not regular emails.

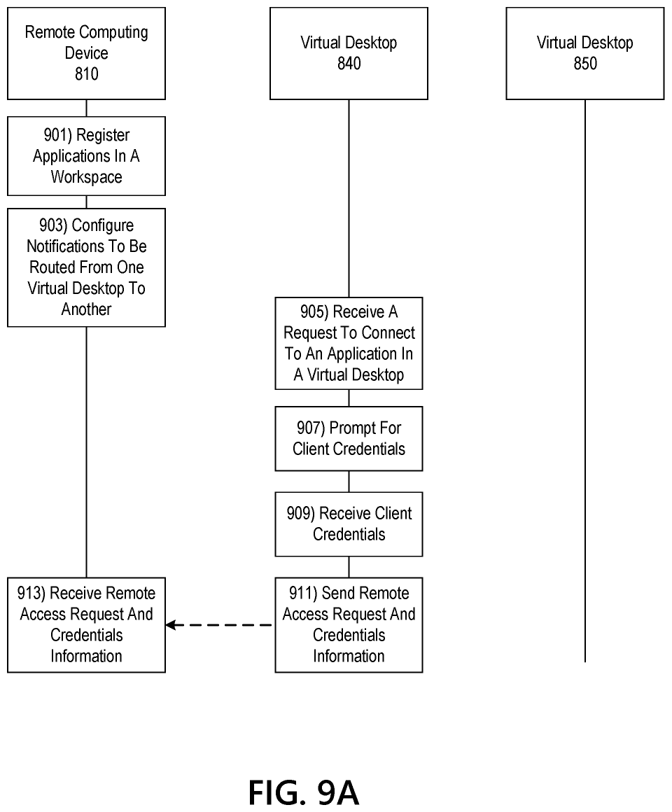

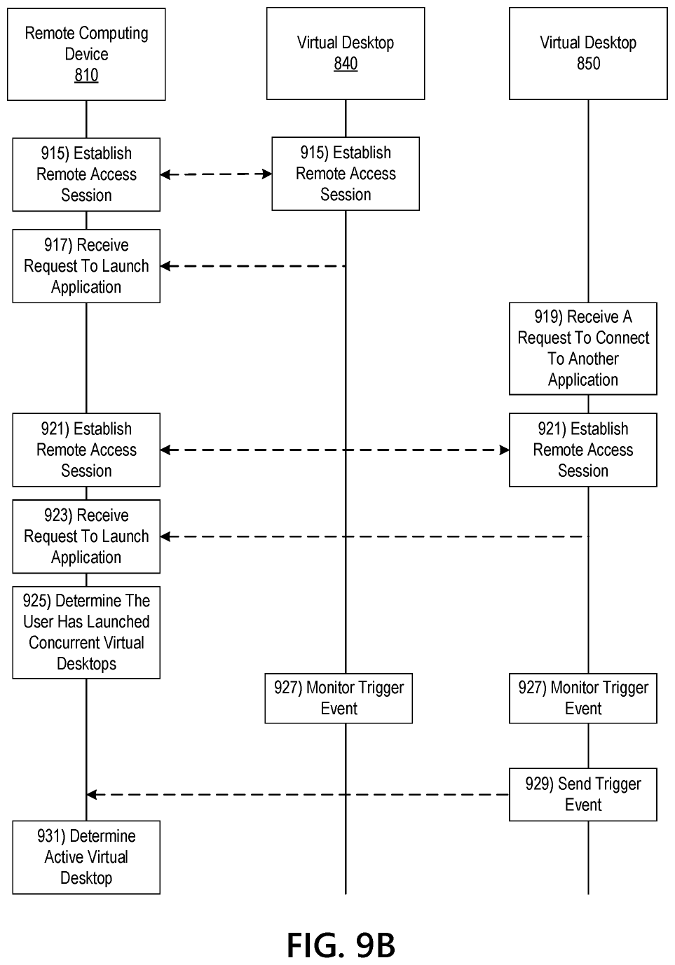

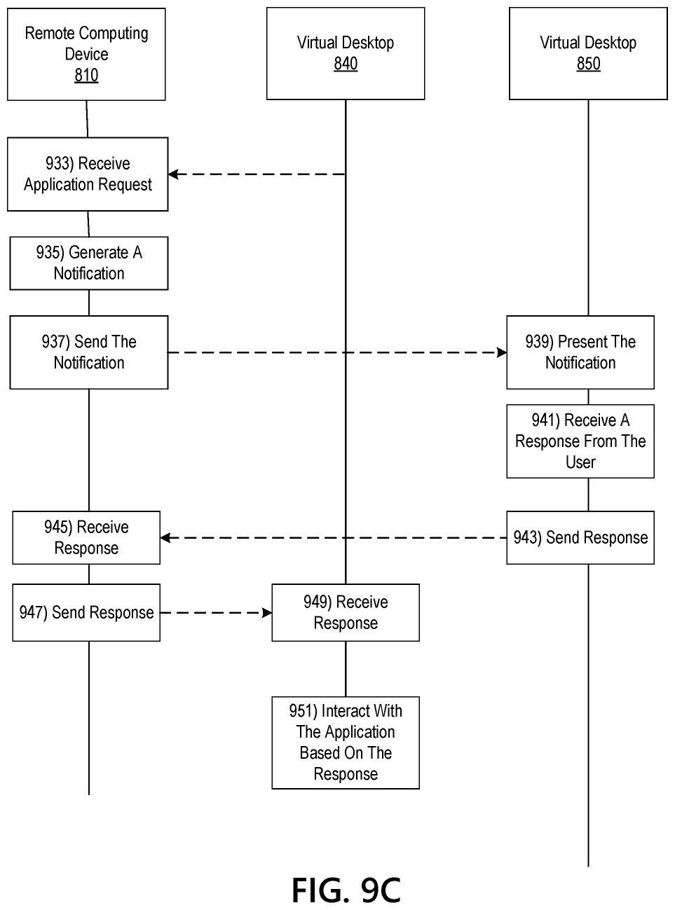

FIGS. 9A-8C depict an example event sequence for implement asymmetric workspace application notification and interaction in accordance with one or more illustrative aspects described herein. Referring to FIG. 9A, at step 901, a computing device (e.g., remote computing device 810) may register applications associated with a user in a workspace. For example, one or more agent processes may register the applications and send the registration information to the computing device. An enterprise administrator or an enterprise user may define several virtual desktops for the enterprise user to support her day-to-day work. For example, a user may have three virtual desktops in her workspace to support various roles and functions she serves within the organization, so that the enterprise user may focus on specific tasks and work more effectively. A first virtual desktop, a corporate workspace, may be related to her role as a corporate user. The second virtual desktop, a developer workspace, may be related to her role as a software developer. A third virtual desktop, a person workspace, may be related to her personal capacity. A user may select various applications (e.g., workspace applications) to be installed in each virtual desktop. For example, the first virtual desktop may include applications such as Teams (e.g., using the user's corporate account) for the user to interact with her peers, Outlook for the user to send and receive emails, PowerPoint and Word for the user to draft documents. The second virtual desktop may include applications such as a Visual Studio for coding, and Slack for chatting with fellow developers. The third virtual desktop may include Teams (e.g., using the user's personal account), Spotify, WhatsApp and Facebook for personal communications and enjoyment. Through the registration step, the remote computing device may provide a view customized for a specific user in her workspace. The view may include concurrent virtual desktops via remote sessions and accessible from an endpoint device of the user, while each virtual desktop may include the same or different applications installed and tailored to support specific roles and functions of the user.

At step 903, the remote computing device (e.g., remote computing device 810) may configure notifications to be routed from one virtual desktop to another. For example, the remote computing device may provide an interface via an agent process for the user to select the applications and type of notifications to be routed to another virtual desktop if needed. For example, the user may select from Outlook, that emails sent with high priority are to be routed to an active virtual desktop. The user may select that Calendar reminders for upcoming meetings, and the notifications for such meetings within 15 minute of starting time may be routed to the active virtual desktop. The user might not select any person emails or low priority work emails to be routed to the active virtual desktop. The notifications may be customized for each user to adapt to her work habits and preferences to increase productivity.

The conventional virtual desktop solution may provide a unique view for all enterprise users based on configuration for their assigned virtual desktops. There might not be a way to facilitate a user to get information on various virtual desktops or to interact with different workspace applications among different virtual desktops. To resolve the issues in the conventional system, the asymmetric workspace solution described herein may track the virtual desktops and applications for the enterprise users using the agent processes, and provide a mechanism allowing the applications to effectively interact with the user even if the applications might not be installed on the virtual desktop that the user is actively working on.

At step 905, an endpoint device (e.g., an Agent Process or a remote access module on an endpoint device) may receive a request to connect to an application (e.g., a workspace application) or a desktop. For example, the endpoint device 820 may be located on a network, different than an enterprise network corresponding to the remote computing device 810 or a virtual server (not shown in FIG. 8B), and thus a request may be received to connect to a web browsing application in order to access resources in the enterprise network. The application may be configured to be executed in the virtual desktop 840. The endpoint device 820 may receive the request to connect to the web browsing application by receiving a user input via a display of the endpoint device 820 or another input mechanism corresponding to the endpoint device 820 (keyboard input, mouse input, or the like).

At step 907, after receiving the request to connect to the remote application received at step 803, the endpoint device 820 may prompt a user to input credentials. For example, the endpoint device 820 may prompt the user to provide authentication information verifying that the user is permitted to access the enterprise network. In some instances, in prompting for the credentials, the endpoint device 820 may prompt for a username, password, authentication key, and/or other authentication information (which may, in some instances, include multifactor authentication). These credentials may be used by the remote computing device 810 to authenticate the user.

At step 909, the endpoint device 820 may receive the credentials requested at step 907. At step 911, the endpoint device 820 may send the request to connect to the remote application, along with the credentials received at step 909, to the remote computing device 810 or the virtual server. The endpoint device 820 may send security information indicating device integrity corresponding to the endpoint device 820. For example, the endpoint device 820 may generate a numeric identifier and/or other indication of an integrity level of the endpoint device 820 (e.g., based on whether or not the endpoint device 820 is rooted, or other security information), and may send this information to the remote computing device 810 or the virtual server. The endpoint device 820 may also send the security information at a later time once the remote access session is established.

At step 913, the remote computing device 810 or the virtual server may receive the request to connect to the remote application, credentials, and/or security information from the endpoint device 820. The remote computing device 810 or the virtual server may attempt to validate the received credentials. If the remote computing device 810 validates the received credentials, the remote computing device 810 or the virtual server may proceed to step 815 of FIG. 8B. If the remote computing device 810 or the virtual server determines that the received credentials are invalid, the remote computing device 810 or the virtual server may send a notification to the endpoint device 820, indicating that the received credentials were not authenticated and requesting updated credentials.

Referring to FIG. 9B, at step 915, based on or in response to authenticating the credentials at step 913, the remote computing device 810 or the virtual server may establish a remote access session with the endpoint device 820. For example, the remote computing device 810 or the virtual server may allow the endpoint device 820 to operate on the enterprise network from a remote location.

At step 917, while the remote access session is established with a computing device (e.g., the remote computing device 810 or the virtual server), the computing device may receive a remote application or desktop request to launch an application (e.g., a workspace application) accessible from the endpoint device 820. The computing device may receive this request based on an input received at the endpoint device 820. The user input may be received within the client application associated with the endpoint device 820, and interpreted by the remote computing device 810 or the virtual server (e.g., rather than at endpoint device 820) due to the established remote application or desktop session. The remote computing device or the virtual server may determine that the application is to be executed in virtual desktop 840.

At step 919, the endpoint device (e.g., the endpoint device 820) may receive a request to connect to another application (e.g., workspace application). For example, the request may be received to connect to a Visual Basic application. The application may be configured to be executed in the virtual desktop 850. Similar to step 905, the endpoint device 820 may receive the request to connect to the Visual Basic application by receiving a user input via a display of the endpoint device 820 or another input mechanism corresponding to the endpoint device 820 (keyboard input, mouse input, or the like). At step 921, the remote computing device 810 or the virtual server may establish another remote access session with the endpoint device 820. At step 923, while the remote access session is established with a computing device (e.g., the remote computing device 810 or the virtual server), the computing device may receive a remote application or desktop request to launch the application (e.g., the Visual Basic application) accessible from the endpoint device 820. The remote computing device 810 or the virtual server may determine that the application is to be executed in virtual desktop 850.

At step 925, the remote computing device 810 may communicate with agent processes to determine that the user has launched concurrent virtual desktops. For example, the remote computing device 810 may receive session information from the agent processes that there are two concurrent remote access sessions accessible from the endpoint device 820. The first remote access session was established with virtual desktop 840 and the second remote access session was established with virtual desktop 850. The remote computing device 810 may receive session information from other agent processes indicating additional remote access sessions with virtual desktops, such as virtual desktop 860 (not shown in FIG. 9.)

At step 927, the agent processes may monitor one or more trigger events. The trigger events may occur in the virtual desktops 840 and 850, or any other virtual desktop that has established a remote access session with the remote computing device 810. The agent processes may use the trigger event to determine the status of the virtual desktops, for example, whether the user is currently present or actively works in a particular virtual desktop. The trigger events may include system events or user events. Monitoring the system events may include, for example, using Windows API to determine whether the user is physically present in the virtual desktop or using system API calls to determine whether the user is actively working in the virtual desktop.

The user events may include user interactions with the mouse, keyboard, microphone and other input devices. For example, using a virtual trackpad, keyboard input, or other virtual input device, a user may interact with a workspace application via an image (e.g., icon) of application displayed in the virtual desktop. Such input being received on the virtual desktop may include a variety of instrument, hand, or finger movements, and actions including touching a point on the screen, stylus pen inputs, or the like. In some examples, the touch input may be converted into mouse events or other types of input events for an application that is not configured to receive and process touch input.

The remote endpoint device 810 may use an Agent Process running on the virtual desktop to monitor the trigger event. For example, Agent Process 848 may monitor the trigger events on virtual desktop 840, Agent Process 858 may monitor the trigger events on virtual desktop 850 and Agent Process 868 may monitor the trigger events on virtual desktop 860. Agent Process 858 may detect user interactions with the mouse and keyboard in virtual desktop 850. In contrast, Agent Processes 848 and 868 might not detect any user interactions with the mouse and keyboard in virtual desktops 840 and 860.

In some examples, the Agent Processes may track various activities occurring in the virtual desktops and provide a mechanism allowing a workspace application to effectively interact with the user even if the application is not installed on a virtual desktop that the user is actively working on. The Agent Processes may log and record the login or starting of each user access to the virtual desktops. The Agent Processes may be new independent processes, or may be integrated with any existing component that provides the remote desktop service. The Agent Processes may collect session data such as the virtual desktop network addresses, user accounts and any other information relevant to monitor the status of the virtual desktops. The collected session data may be transferred to the remote computing device 810 and may be recorded, so that later launched sessions may have the knowledge of previous existing sessions when they connect the service at initiation. The Agent Process running on each virtual desktop may communicate with the remote computing device 810 and fetch any correlated session data that may belong to the same user and may communicate with any pre-existing sessions to start sharing or receiving data.

At step 929, an Agent Process may send the trigger event to the remote computing device 810. For example, Agent Process 858 may send the trigger event related to user interactions with the mouse and keyboard from virtual desktop 850 to the remote computing device 810. On the other hand, Agent Processes 848 and 868 might not detect any user interactions with the mouse and keyboard in virtual desktops 840 and 860 and might not send such trigger event to remote computing device 810.

At step 931, the remote computing device 810 may communicate with the agent processes to determine the active virtual desktop at any given time. For example, based on the user event, system event or a user status sent from Agent Process 858, the remote computing device 810 may determine that the user is actively working in virtual desktop 850, which is an active at the moment. Agent Processes 848 and 868 might not detect any user interactions with the mouse and keyboard in virtual desktops 840 and 860, which might not be active at the moment. In some examples, based on the use status of the virtual desktop, the Agent Process running in the virtual desktop may identify that the user is not actively working on this virtual desktop. The Agent Process may find another virtual desktop that the user is actively working on through its communication with another Agent Process running in the active virtual desktop.

At step 933, the remote computing device 810 may receive an application notification from the virtual desktop. For example, the application notification may be received from Agent Process 848 on virtual desktop 840. The application notification may be generated from a virtual application on virtual desktop 840. Agent Process 848 may monitor the workspace applications running in virtual desk 840 and detect any application notification received or generated in virtual desktop 840. For example, the Agent Processes may receive calls or passively intercept notifications through underlying system from the application, or any related application add-ons or plugins through defined interface. The application notification may include, for example, a calendar event, an email, or a notification that may need user's attention. For example, Agent Process 848 may detect an application notification, such as an Outlook invite, being received in virtual desktop 840 that might need user's attention. Agent Process 848 may send the application notification to the remoting computing device 810. Based on the configuration step 903, the remote computing device 810 may determine that the application notification related to the calendar event may need to be routed to the active virtual desktop. Otherwise, the remote computing device 810 may choose to ignore the application notification if it is not configured to route such request to the active virtual desktop. In some examples, Agent Process 848 may only monitor application notifications that are configured to be routed to another virtual desktop and send such requests to the remote computing device 810.

In some examples, the Agent Processes may capture application notification, for example, through Windows notification, from various workspace applications that installed on the virtual desktops. These workspace applications may be running in different virtual desktops associated with the user. More complicated interactions such as detailed notification or triggerable operation may be integrated through application add-ons or plugins. This may enable user to operate with an application interactively and remotely from another virtual desktop that may or may not have the application installed. For example, the application add-ons or plugins may be implemented using Slack bots. A bot may be a nifty way to run code and automate messages and tasks. Slack is a messaging application that may connect different users to the information they need. In Slack, a bot may be controlled programmatically via a bot user token that may access one or more of Slack's APIs that facilitate the messaging processes.

At step 935, the remote computing device 810 may generate a notification based on the received application notification. For example, the generated notification may be the same or different from the received application notification. The generated notification may include the body or keywords of the calendar invite and an option for the user to accept or decline the invite. The notification may also include a field for the user to input a simple response to the invite. However, the notification may be intended for the user to provide a quick response to accept or dismiss the invite, and might not replace the full functionality or operations of the calendar application running in virtual desktop 840. For more complex operations on the invite, the user may switch back from the active virtual desktop to virtual desktop 840, where the calendar application is originally installed and executed.

At step 937, the remote computing device 810 may send the application notification or the generated notification to the active virtual desktop that the user is currently working on. For example, the remote computing device 810 may communicate with the agent process to determine that the user is actively working on virtual desktop 850 at the moment and send the notification to virtual desktop 850.

At step 939, the notification may be presented to the user in virtual desktop 850. The remote computing device 810 may cause the presentation of the notification or Agent Process 858 may present the notification to the user in virtual desktop 850. The notification may be presented as a virtual application in virtual desktop 850. For example, virtual desktop 850 may provide a graphical environment or space in which one or more applications may be hosted and/or executed. Virtual desktop 850 may include a graphical shell providing a user interface for an instance of an operating system in which the virtual application (e.g., the notification) may be integrated.

At step 941, Agent Process 858 may receive a response from the user, such as an indication of an acceptance of the invite. If the application notification requires some callback or input, the Agent Process 858 may collect the user feedback. At step 943, Agent Process 858 may send the response to the remote computing device 810.

At step 945, the remote computing device 810 may receive the response. At step 947, the remote computing device 810 may send the response to the virtual desktop where the application notification was originally generated. For example, the remote computing device 810 may send the response to Agent Process 848 in virtual desktop 840.

At step 949, Agent Process 848 may receive the response from the remote computing device 810. At step 951, Agent Process 848 may interact with the application locally in virtual desktop 840 based on the response. For example, Agent Process 848 may supply the response to the calendar application in virtual desktop 840 and the calendar application may send the response to the organizer of the event.

Steps 933-951 illustrate the event sequence that the remote computing device may act as an intermediate between Agent Processes 848 and 858. In some examples, Agent Processes 848 and 858 may communicate directly. For example, Agent Process 848 may receive an application notification from the calendar application running in virtual desktop 840. Agent Process 848 may determine that the user is not physical present or actively working in virtual desktop 840 at the moment. Agent Process 848 may communication with Agent Process 858 and Agent Process 858 may send an indication that the user is actively working in virtual desktop 850 at the moment. Agent Process 848 may send a notification related to the application notification to Agent Process 858. Agent Process 858 may receive the notification and present the notification to the user in virtual desktop 850. Agent Process 858 may receive a response such as an indication of an acceptance of the invite from the user. Agent Process 858 may send the response to Agent Process 848 in virtual desktop 840 where the application notification was originated. Agent Process 848 may interact locally with the calendar application in virtual desktop 840 based on the response.

The asymmetric workspace application and notification described herein may be implemented via various Agent Processes installed on the virtual desktops. As noted above, the Agent Processes may log and record the login and starting of each user access to the virtual desktop. The Agent Processes may collect session data such as the virtual desktop network addresses, user accounts and any other information related to the session. The session data may be transferred to the remote computing device 810 and also may be communicated among the Agent Processes. For example, the session data may be sent to the remote computing device 810 and to be recorded in a data store or a database, so that later sessions may have the knowledge of previous existing sessions when they connect the service at initiation via the Agent Processes. The Agent Process running on each virtual desktop may communicate with the remote computing device 810 and fetch any correlated session data that may belong to the same user to communicate with any pre-existing session to start sharing or receiving data among the Agent Processes.

The Agent Processes may collect system events or user events to determine whether a user is actively working on a particular virtual desktop. The Agent Processes may check whether there is keyboard or mouse action events, or microphone inputs. The Agent Processes may collect additional data such as session status to finalize a more solid result on the status of the virtual desktop. Through the interaction of multiple Agent Processes, the Agent Processes may determine which virtual desktop that the user is actively working on at the moment. If the current virtual desktop where a notification is received or generated is not active at the moment, the Agent Processes may route the application notification or interaction to the active virtual desktop that may eventually catch the attention of the user. The Agent Processes may use multiple factors to determine whether the user may be actively working in a particular virtual desktop. These factors may include, for example, user related input and possible timers to record the time lapsed since the last user input was detected. The Agent Processes or the remote computing device may also use various weight factors to finalize a result of the status of the virtual desktop. For example, a mouse input from the user may be more indicative of whether the user is actively working on the virtual desktop. The mouse input may be assigned with a relatively greater weight than, for example, the input received from the microphone.

The Agent Processes may present the notification or interactive operation to the user. For example, the notification may be presented to the user using the interface defined and provided by application add-ons or plugins. The notification may be presented as a virtual application in the active virtual desktop. The user may receive the notification in the active virtual desktop that she is currently working on, or operate and react to trigger action to the workspace application running remotely in another virtual desktop through the same interface.

In some examples, the security communication among Agent Processes may be implemented, for example on Windows machine, using Windows based communicate mechanism such as Windows Communication Foundation (WCF), which is a framework for building service-oriented applications. Using WCF, a user may send data as asynchronous messages from one service endpoint to another. A service endpoint may be part of a continuously available service hosted by HS, or may be a service hosted in an application. WCF may identify the actual user security context and complete basic authentication. If the remote desktop solution is using other third-party user authentication system, such system may be used to issue user-based certificate or user-based signature to help the Agent Processes authenticate incoming traffic.

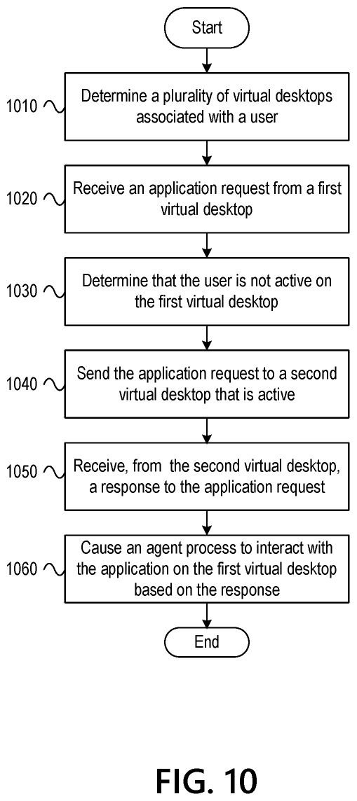

FIG. 10 depicts an illustrative example of a method for implementing asymmetric workspace application notification and interaction in accordance with one or more illustrative aspects described herein. One or more steps of the method may be performed by a computing device such as remote computing device 810. Referring to FIG. 10, at step 1010, a computing device having at least one processor, a communication interface, and memory may determine a plurality of virtual desktops accessible from an endpoint device via one or more remote sessions associated with a user. At step 1020, the computing device may receive, from a first agent process running on a first virtual desktop, an application notification generated from an application installed on the first virtual desktop. At step 1030, the computing device may communicate with an agent process and determine that the user is not active on the first virtual desktop. At step 1040, the computing device may communicate with the same or different agent process as in step 1030 and determine that the user is active on a second virtual desktop, and send the application notification to the second virtual desktop. At step 1050, the computing device may receive, from a second agent process running on the second virtual desktop, a response to the application notification. At step 1060, the computing device may cause the first agent process to interact with the application on the first virtual desktop based on the response.

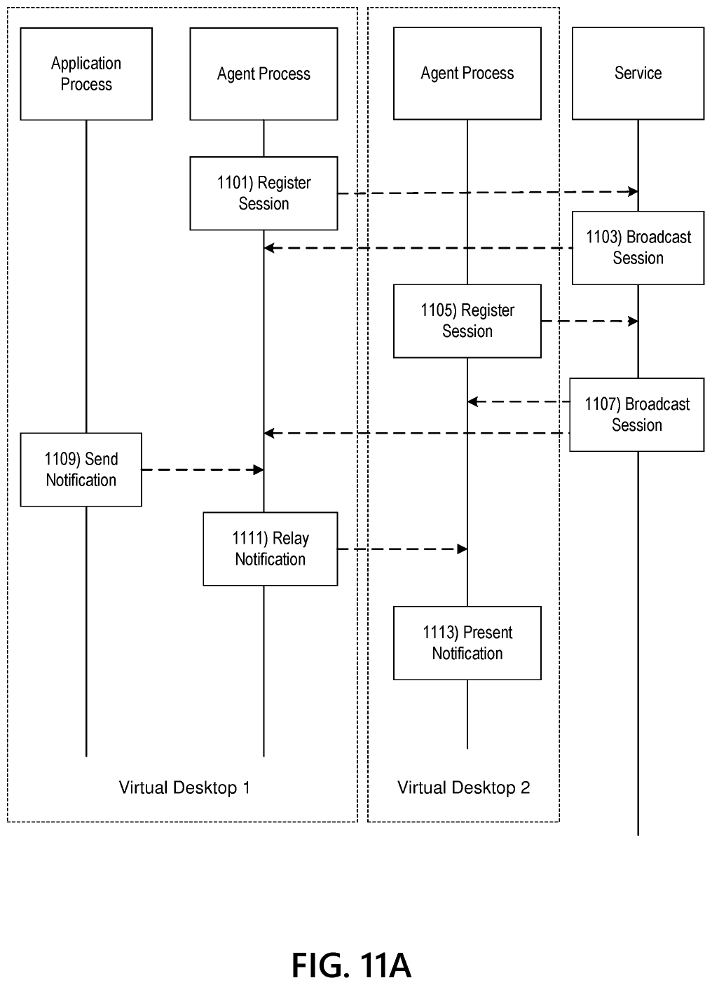

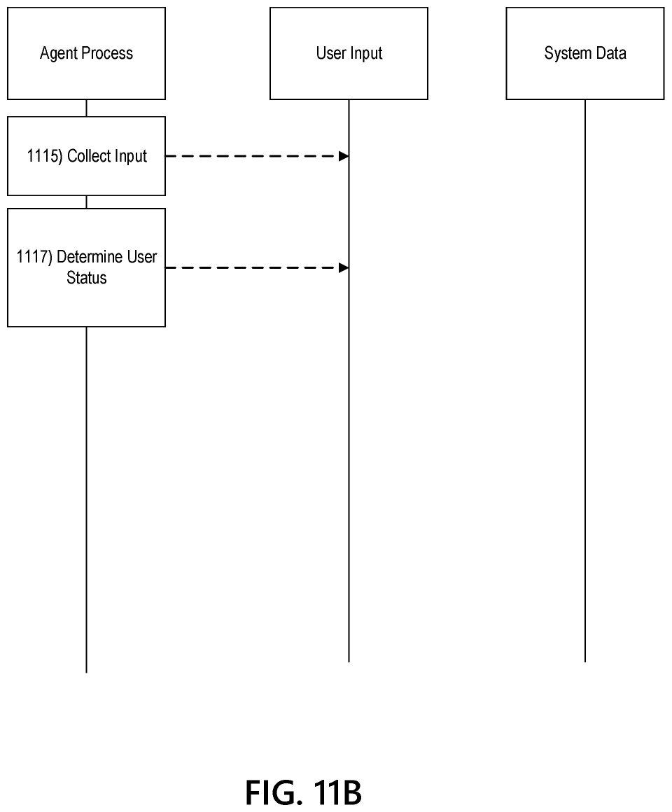

FIG. 11A depicts an example event sequence for implementing asymmetric workspace application notification and interaction using one or more agent processes in accordance with one or more illustrative aspects described herein.

At step 1101, an agent process (e.g., a user session agent) in virtual desktop 1 may register the session with a service that implements the asymmetric workspace application notification and interaction service. For example, when the user establishes a remote session in virtual desktop 1, the agent process running in virtual desktop 1 may register the remote session with the service (e.g., a remote computing device 810 that hosts the asymmetric workspace application notification and interaction service). The agent process may collect session data such as the virtual desktop network addresses, user accounts and any other information relevant to monitoring the status of the virtual desktop 1. The agent process may send the session data in virtual desktop 1 to the remote computing device 810.

At step 1103, the service may broadcast session data related to the registered remote session. In the example illustrated in FIG. 11A, there is only one agent process running at the time (e.g., user session agent in virtual desktop 1). The service may broadcast the session data to the agent process in virtual desktop 1.

At step 1105, the agent process (e.g., the user session agent) in virtual desktop 2 may register the session with the asymmetric workspace application notification and interaction service. The agent process may collect session data relevant to monitor the status of the virtual desktop 2 and send the session data to the remote computing device 810.

At step 1107, the remote computing device may broadcast session data related to the registered remote session. The remote computing device may receive session data from the agent processes in virtual desktops 1 and 2. The session data may indicate the user status of virtual desktops 1 and 2. The remote computing device may broadcast the session data to the agent processes in both virtual desktops 1 and 2. As such, the agent process in virtual desktop 1 may have knowledge of the user status of virtual desktop 2, and the agent process in virtual desktop 2 may have knowledge of the user status of virtual desktop 1. If there are any additional virtual desktops running concurrently for the user, the remote computing device may also broadcast session data of virtual desktops 1 and 2 to the additional virtual desktops. Likewise, the remote computing device may also collect session data of additional virtual desktops and broadcast to agent processes in virtual desktops 1 and 2 so that concurrent virtual desktops would have knowledge of the user status of each other.

At step 1109, an application process may send an application notification to an agent process. The application process may be running in virtual desktop 1 and capture a notification generated in an application executing in virtual desktop 1. For example, the application process may capture a Microsoft Teams invite and send a notification related to the Teams invite to the agent process in virtual desktop 1.

At step 1111, the agent process may relay the application notification to another agent process. For example, the agent process (e.g., the user session agent) in virtual desktop 1 may determine that the virtual desktop is active at the moment based on the broadcast session data. The agent process in virtual desktop 1 may relay the application notification to the agent process (e.g., the user session agent) in virtual desktop 2.

At step 1113, after receiving the relayed notification from the agent process in virtual desktop 1, the agent process in virtual desktop 2 may present the notification in virtual desktop 2. The user who is actively working in virtual desktop 2 may choose to respond to the application notification, for example, to accept the Teams invite. The subsequent steps may be similar to steps 943 to 951 as illustrated in FIG. 9.

FIG. 11B depicts an example event sequence using one or more agent processes to determine a user status in a virtual desktop in accordance with one or more illustrative aspects described herein. At step 1115, an agent process (e.g., a user session agent) may collect input including user input and system data in virtual desktop 1. The user input may include user event comprising user interactions with the mouse, keyboard, microphone and other input devices. The system data may include system events related to, for example, using Windows API to determine whether the user is physically present in the virtual desktop or using system API calls to determine whether the user is actively working in the virtual desktop.

At step 1117, the agent process may determine the user status in virtual desktop 1 based on the collected input. Various agent processes may send or report the user status in the corresponding virtual desktop to the service hosted by the remote computing device, which may in turn broadcast the user status to agent processes in the concurrent virtual desktops.

The following paragraphs (M1) through (M10) describe examples of methods that may be implemented in accordance with the present disclosure.

(M1) A method comprising determining, by a computing device, a plurality of virtual desktops accessible from an endpoint device via one or more remote sessions associated with a user; receiving, by the computing device and from a first agent process running on a first virtual desktop, an application notification generated from an application installed on the first virtual desktop; after determining that the user is active on a second virtual desktop, sending the application notification to the second virtual desktop; receiving, by the computing device and from a second agent process running on the second virtual desktop, a response to the application notification; and causing, by the computing device, the first agent process to interact with the application on the first virtual desktop based on the response.

(M2) A method may be performed as described in paragraph (M1) further comprising receiving, by the computing device and from the second agent process, system events or user events in the second virtual desktop; and determining, by the computing device, whether the user is active on the second virtual desktop based on the received system events or user events.

(M3) A method may be performed as described in paragraph (M2) wherein the user events comprise user interactions with a mouse, a keyboard or a microphone.

(M4) A method may be performed as described in paragraph (M2) wherein the system events comprise system API calls to determine whether the user is active in the second virtual desktop.

(M5) A method may be performed as described in paragraph (M2), further comprising: determining, based on the system events or the user events from the first agent process, the user is not active on the first virtual desktop.

(M6) A method may be performed as described in paragraph (M1) further comprising receiving, by the computing device and from the first agent process, the application notification; and sending, to the second agent process, the application notification.

(M7) A method may be performed as described in paragraph (M1) wherein sending the application notification comprises: causing, by the computing device, the first agent process to send session information comprising the application notification to the second agent process.

(M8) A method may be performed as described in paragraph (M1) wherein receiving the response to the application notification: causing, by the computing device, the second agent process to send session information comprising the response to the application notification to the first agent process.

(M9) A method may be performed as described in paragraph (M1) further comprising: prior to detecting the plurality of virtual desktops, registering one or more applications executed in the plurality of virtual desktops associated with the user; and configuring notifications associated with the one or more applications to be routed from one virtual desktop to another virtual desktop, wherein the notifications are associated with the application notification and the response to the application notification.

(M10) A method may be performed as described in paragraph (M1) wherein the plurality of virtual desktops are associated with concurrent remote sessions launched for the user.

The following paragraphs (A1) through (A9) describe examples of apparatuses that may be implemented in accordance with the present disclosure.

(A1) A computing device, comprising: at least one processor and memory storing computer-readable instructions that, when executed by the at least one processor, cause the computing device to: determine a plurality of virtual desktops accessible from an endpoint device via one or more remote sessions associated with a user; receive, from a first agent process running on a first virtual desktop, an application notification generated from an application installed on the first virtual desktop; after determining that the user is active on a second virtual desktop, send the application notification to the second virtual desktop; receive, from a second agent process running on the second virtual desktop, a response to the application notification; and cause the first agent process to interact with the application on the first virtual desktop based on the response.

(A2) The computing device as described in paragraph (A1) wherein the memory stores additional computer-readable instructions, that when executed by the at least one processor, cause the computing device to receive system events or user events from the second agent process in the second virtual desktop; and determine whether the user is active on the second virtual desktop based on the received system events or user events.

(A3) The computing device as described in paragraph (A2) wherein the user events comprise user interactions with a mouse, a keyboard or a microphone.

(A4) The computing device as described in paragraph (A2) wherein the system events comprise system API calls to determine whether the user is active in the second virtual desktop.

(A5) The computing device as described in paragraph (A2) wherein the memory stores additional computer-readable instructions, that when executed by the at least one processor, cause the computing device to determine, based on the system events or the user events from the first agent process, the user is not active on the first virtual desktop.

(A6) The computing device as described in paragraph (A2) wherein the memory stores additional computer-readable instructions, that when executed by the at least one processor, cause the computing device to send the application notification to the second virtual desktop by: receiving, from the first agent process, the application notification; and sending, to the second agent process, the application notification.

(A7) The computing device as described in paragraph (A1) wherein the memory stores additional computer-readable instructions, that when executed by the at least one processor, cause the computing device to send the application notification by: causing the first agent process to send session information comprising the application notification to the second agent process.

(A8) The computing device as described in paragraph (A1) wherein the memory stores additional computer-readable instructions, that when executed by the at least one processor, cause the computing device to receive the response to the application notification by: causing the second agent process to send session information comprising the response to the application notification to the first agent process.

(A9) The computing device as described in paragraph (A1) wherein the plurality of virtual desktops are associated with concurrent remote sessions launched for the user.

The following paragraph (CRM1) describes an example of a computer-readable medium that may be implemented in accordance with the present disclosure.

(CRM1) One or more non-transitory computer-readable media storing instructions that, when executed by a computing device comprising at least one processor and memory, cause the computing device to: determine a plurality of virtual desktops accessible from an endpoint device via one or more remote sessions associated with a user; receive, from a first agent process running on a first virtual desktop, an application notification generated from an application installed on the first virtual desktop; after determining that the user is active on a second virtual desktop, send the application notification to the second virtual desktop; receive, from a second agent process running on the second virtual desktop, a response to the application notification; and cause the first agent process to interact with the application on the first virtual desktop based on the response.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
determining, by a computing device, a plurality of virtual desktops accessible from an endpoint device via one or more remote sessions associated with a user;
receiving, by the computing device and from a first agent process running on a first virtual desktop, an application notification generated from an application installed on the first virtual desktop;
after determining that the user is active on a second virtual desktop, sending the application notification to the second virtual desktop;
receiving, by the computing device and from a second agent process running on the second virtual desktop, a response to the application notification; and
causing, by the computing device, the first agent process to interact with the application on the first virtual desktop based on the response.

2. The method of claim 1, wherein determining that the user is active on the second virtual desktop comprises:
receiving, by the computing device and from the second agent process, system events or user events in the second virtual desktop; and
determining, by the computing device, whether the user is active on the second virtual desktop based on the received system events or user events.

3. The method of claim 2, wherein the user events comprise user interactions with a mouse, a keyboard or a microphone.

4. The method of claim 2, wherein the system events comprise system API calls to determine whether the user is active in the second virtual desktop.

5. The method of claim 2, further comprising:
determining, based on the system events or the user events received from the first agent process, the user is not active on the first virtual desktop.

6. The method of claim 1, wherein sending the application notification to the second virtual desktop comprises:
receiving, by the computing device and from the first agent process, the application notification; and
sending, by the computing device and to the second agent process, the application notification.

7. The method of claim 1, wherein sending the application notification comprises:
causing, by the computing device, the first agent process to send session information comprising the application notification to the second agent process.

8. The method of claim 1, wherein receiving the response to the application notification:
causing, by the computing device, the second agent process to send session information comprising the response to the application notification to the first agent process.

9. The method of claim 1, further comprising:
prior to detecting the plurality of virtual desktops, registering one or more applications executed in the plurality of virtual desktops associated with the user; and
configuring notifications associated with the one or more applications to be routed from one virtual desktop to another virtual desktop, wherein the notifications are associated with the application notification and the response to the application notification.

10. The method of claim 1, wherein the plurality of virtual desktops are associated with concurrent remote sessions launched for the user.

11. A computing device, comprising:
at least one processor; and
memory storing computer-readable instructions that, when executed by the at least one processor, cause the computing device to:
determine a plurality of virtual desktops accessible from an endpoint device via one or more remote sessions associated with a user;
receive, from a first agent process running on a first virtual desktop, an application notification generated from an application installed on the first virtual desktop;
after determining that the user is active on a second virtual desktop, send the application notification to the second virtual desktop;
receive, from a second agent process running on the second virtual desktop, a response to the application notification; and
cause the first agent process to interact with the application on the first virtual desktop based on the response.

12. The computing device of claim 11, wherein the memory stores additional computer-readable instructions, that when executed by the at least one processor, cause the computing device to:
receive, from the second agent process, system events or user events in the second virtual desktop; and
determine whether the user is active on the second virtual desktop based on the received system events or user events.

13. The computing device of claim 12, wherein the user events comprise user interactions with a mouse, a keyboard or a microphone.

14. The computing device of claim 12, wherein the system events comprise system API calls to determine whether the user is active in the second virtual desktop.

15. The computing device of claim 12, wherein the memory stores additional computer-readable instructions, that when executed by the at least one processor, cause the computing device to:
determining, based on the system events or the user events received from the first agent process, the user is not active on the first virtual desktop.

16. The computing device of claim 11, wherein the memory stores additional computer-readable instructions, that when executed by the at least one processor, cause the computing device to send the application notification to the second virtual desktop by:
receiving, from the first agent process, the application notification; and
sending, to the second agent process, the application notification.

17. The computing device of claim 11, wherein the memory stores additional computer-readable instructions, that when executed by the at least one processor, cause the computing device to send the application notification by:
causing the first agent process to send session information comprising the application notification to the second agent process.

18. The computing device of claim 11, wherein the memory stores additional computer-readable instructions, that when executed by the at least one processor, cause the computing device to receive the response to the application notification by:
causing the second agent process to send session information comprising the response to the application notification to the first agent process.

19. The computing device of claim 11, wherein the plurality of virtual desktops are associated with concurrent remote sessions launched for the user.

20. One or more non-transitory computer-readable media storing instructions that, when executed by a computing device comprising at least one processor and memory, cause the computing device to:
determine a plurality of virtual desktops accessible from an endpoint device via one or more remote sessions associated with a user;
receive, from a first agent process running on a first virtual desktop, an application notification generated from an application installed on the first virtual desktop;
after determining that the user is active on a second virtual desktop, send the application notification to the second virtual desktop;
receive, from a second agent process running on the second virtual desktop, a response to the application notification; and
cause the first agent process to interact with the application on the first virtual desktop based on the response.
